(19) United States
(12) Patent Application Publication
(10) Pub. No.: US 2026/0195071 A1
(43) Pub. Date: Jul. 9, 2026

(54) A METHOD OF PROCESSING SOURCE DATA

(71) Applicant: V-NOVA INTERNATIONAL LIMITED, London (GB)

(72) Inventor: Niusha ALAVI, London (GB)

(21) Appl. No.: 19/134,103

(22) PCT Filed: Nov. 10, 2023
(86) PCT No.: PCT/GB2023/052940

§ 371 Date: May 29, 2025

(30) Foreign Application Priority Data
Nov. 30, 2022 (GB) 2218005.3

(51) Int. Cl. G06F 3/06

(52) U.S. Cl. CPC G06F 3/0659; G06F 3/0604; G06F 3/0673

(57) ABSTRACT

There is provided a computer-implemented method of processing source data with a separable kernel to create output data. The method comprising: convolving a first lower dimension kernel of the separable kernel with the source data to obtain a set of intermediate values. For an intermediate value obtained for a target data point in the source data, the method comprising: combining the intermediate value with the content of a first memory location storing accumulated intermediate values for a first data point in the output data to create a final value for the first data point in the output data, wherein the final value corresponds to a value that the separable kernel would produce if the first data point were processed by the separable kernel; and storing the intermediate value in a second memory location related to a second data point of the output data, wherein the second data point requires the intermediate value to be processed according to the separable kernel.

### TECHNICAL FIELD

The disclosure relates to a computer-implemented method of processing source data to create output data. Particularly, but not exclusively, the invention relates to a computer-implemented method for processing image data as source data, for example, picture data in a video data. Applications of such a technique comprise smoothing, noise reduction, edge detection, and scaling. In particular, the disclosure relates to and uses separable filters. The disclosure is implementable in hardware or software.

### BACKGROUND

In data processing, filters are often used to change or improve the data. For example, in image processing, filters are used to adjust certain attributes of an image such as to suppress any high frequencies in the image e.g., smoothing the image, or to suppress any low frequencies in the image e.g., enhancing or detecting edges in the image.

However, the application of filters to a data signal requires memory resources and computational resources that may not be available at a processor. Therefore, there is a need for a more efficient filtering process.

### SUMMARY

It is an aim of the invention to address one or more of the disadvantages associated with the prior art. Aspects and embodiments of the invention provide a computer-implemented method of processing source data, an apparatus for processing source data, and a computer-readable medium as claimed in the appended claims.

According to a first aspect of the invention, there is provided a computer-implemented method of processing source data with a separable kernel to create output data. The method comprising: convolving a first lower dimension kernel of the separable kernel with the source data to obtain a set of intermediate values. For an intermediate value obtained for a target data point in the source data, the method comprising: combining the intermediate value with the content of a first memory location storing accumulated intermediate values for a first data point in the output data to create a final value for the first data point in the output data, wherein the final value corresponds to a value that the separable kernel would produce if the first data point were processed by the separable kernel; and storing the intermediate value in a second memory location related to a second data point of the output data, wherein the second data point requires the intermediate value to be processed according to the separable kernel.

In this way computational resources necessary for processing source data using a filter are reduced by placing each intermediate value in multiple locations where it would be of used instead of, separately, obtaining/recalculating the intermediate value for each location. Furthermore, memory resources are also conserved by reducing the number of memory reads and writes that would have been used if an intermediate value is obtained multiple times for each data point.

Optionally, wherein the source data is digital image data.

Optionally, wherein the separable kernel is one of: a 2D separable kernel; a 3×3 separable kernel; a 3×3 Gaussian kernel.

Optionally, wherein the first lower dimension kernel is one of: a 1D kernel; a 1D horizontal filter; a 3×1 kernel; a 1D vertical filter; a 1×3 kernel; and a symmetrical kernel of any of the aforementioned kernel types.

Optionally, wherein the first lower dimension kernel is a 1D horizontal kernel and the step of convolving a first lower dimension kernel of the separable kernel with the source data to obtain a set of intermediate values comprises applying the first lower dimension kernel to each data point of the source data in a row-wise manner, and the first data point and the second data point in the output data are arranged in the same column.

Optionally, wherein the first lower dimension kernel is a 1D vertical kernel and the step of convolving a first lower dimension kernel of the separable kernel with the source data to obtain a set of intermediate values comprises applying the first lower dimension kernel to each data point of the source data in a column-wise manner, and the first data point and the second data point in the output data are arranged in the same row.

Optionally, wherein the first data point and the second data point are separated by the target data point of the source signal.

Optionally, wherein the method further comprises: deriving the first lower dimension kernel and a second lower dimension kernel from the separable kernel in such a way so that the second lower dimension kernel has a single non-unitary coefficient, and deriving a scaling factor from the single non-unitary coefficient.

Optionally, wherein the scaling factor is one of the following: 2, 4, or 8.

Optionally, wherein the method comprises applying the scaling factor to the intermediate value and adding the intermediate value to the content of a third memory location used to accumulate values for a target data point in the output data corresponding to the target data point in the input data.

Optionally, wherein the first memory location and the second memory location are the same memory location within a buffer to reuse memory space in the buffer. In this way memory resources are conserved by reusing memory space.

Optionally, wherein the third memory location is in the buffer and is a separate memory location to the first and second memory locations.

Optionally, wherein each of the first memory location, the second memory location and the third memory location are separate locations corresponding to data points in the output data. In this way, memory resources are conserved by outputting the intermediate values immediately the locations corresponding to data points in the output data where it would it be of use. Furthermore, computational resources are also conserved by obtaining each intermediate value once and outputting to all locations where it would be of use.

Optionally, wherein the method comprises moving to a second target data point in the input data, obtaining a resulting second intermediate value, applying the scaling factor to the resulting second intermediate value and combining the scaled subsequent intermediate value with the intermediate value stored in the second memory location.

Optionally, wherein the second target data point is in the row immediately below the target data point.

Optionally, wherein the method comprises moving to a third target data point in the input data, and repeating the process outlined above in relation to the first aspect. In this way, the method usefully combines with a downsampling operation to further reduce computational and memory resource requirements.

Optionally, wherein the third target data point is in the row immediately below the second data point.

Optionally, wherein the method comprises outputting the final value.

Optionally, wherein the outputting the final value comprises outputting the final value to a memory location storing the output data or outputting for streaming.

Optionally, wherein the method is implemented in one of the following: a dedicated hardware such as an Application Specific Integrated Circuit, ASIC, or Field Programmable Gate Arrays, FPGA; software running on a Central Processing Unit, CPU; software running on a Graphical Processing Unit, GPU.

According to a second aspect of the invention, there is provided an apparatus for processing a source data. The apparatus is arranged to perform the computer-implemented method of any of preceding method statement.

According to a third aspect of the invention, there is provided a computer-readable medium comprising instructions which when executed cause a processor to perform the method of any preceding method statement.

Some new hierarchical video codecs, such as LCEVC, operate by receiving a relatively high-resolution video frame which is downsampled to generate a relatively low-resolution frame. The high resolution and/or the low-resolution frame is processed during coding. The low-resolution frame is often encoded with a base codec for ouput. The encoded version is often decoded by the base codec and the decoded version compared with the low-resolution frame to generate differences, or residual values. Moreover, the generated low-resolution frame or decoded version thereof is often upsampled as part of the coding process, and the upsampled rendition thereof is often utilised and/or processed, for example by comparing the upsampled rendition to the high-resolution frame to generate differences, or residual values. Such techniques have been shown to have increased performance (e.g. increased compression efficiency, better flexibility) over non-hierarchical codecs. Filtering operations are often used in such techniques. However, the filtering operations, upsampling operations and downsampling operations (which are not found in ‘traditional single layer’ coding schemes) use up memory, memory bandwidth, and add extra time to the encoding and decoding pipeline. This can be particularly problematic if the coding scheme is being used to encode/decode high resolution images (e.g. 4 k and/or 8 k) and/or high frame rate videos (e.g. 60 frames per second, 120 fps or higher) and/or real time video (e.g. live sports events). During such examples (i.e. high-resolution real-time encoding), memory, memory bandwidth and latency need to be reduced as much as possible.

As mentioned, up/downsampling (and/or filtering) is not usually performed by traditional ‘single layer’ coding schemes.

Therefore, embodiments of the invention provide a new low latency, low memory and memory bandwidth filtering and up/down sampling operation that is especially useful when used as part of the aforementioned hierarchical coding schemes (e.g. especially when encoding real time and/or high-resolution video).

A further aspect comprises a method of encoding, the method comprising performing an operation according to the above-disclosed aspects of the invention on an input frame to generate a downsampled frame, upsampling according to the above-disclosed aspects of the invention a rendition of the downsampled frame to generate an upsampled frame, comparing the upsampled frame with the input frame to generate residuals, and encoding said residuals.

Preferably, the method further comprises: sending the downsampled frame to a base encoder to generate a base encoding of the downsampled frame; receiving, from a base decoder, a decoded version of the base encoding of the downsampled frame; comparing the downsampled frame with the a decoded version of the base encoding of the downsampled frame to generate a further set of residuals.

Preferably, the method further comprises generating the rendition of the downsampled frame by: combining a rendition of the further set of residuals with the decoded version of the base encoding of the downsampled frame.

Preferably method further comprises generating the rendition of the further set of residuals by transforming the residuals and inverse transforming the transformed residuals.

Preferably method further comprises generating the rendition of the further set of residuals by: transforming the residuals; quantising the transformed residuals; inverse quantising the quantised transformed residuals; inverse transforming the output of the inverse quantising.

### BRIEF DESCRIPTION OF THE DRAWINGS

The invention shall now be described, by way of example only, with reference to the accompanying drawings in which:

FIG. 1 shows an example of an input data, kernel and output data useful for understanding the invention;

FIG. 2 shows an example separable kernel provides useful context for understanding the invention;

FIG. 3 is a flowchart explaining a first aspect of the invention;

FIG. 4 is a block diagram showing in more detail how the generalised method described would work in an exemplary embodiment of the invention;

FIG. 5 is a flowchart explaining a second aspect of the invention showing a buffer embodiment which is able to reuse memory space while accumulating intermediate and scaled intermediate values in order to obtain final values in the output data;

FIG. 6 is a block diagram showing in more detail how the method described in FIG. 5 would work in an exemplary embodiment of the invention;

FIG. 7 is a generalised schematic showing example data values or pixel values for an example 4×4 source data processed into output data according to FIG. 5 and FIG. 6;

FIG. 8 is a flow diagram of a method of processing a data signal according to another aspect of the invention;

FIG. 9 is a block diagram showing in more detail how the method described in FIG. 8 would work in another exemplary embodiment of the invention;

FIG. 10 is a generalised schematic showing example data values or pixel values for an example 4×4 source data processed into output data according to FIG. 8 and FIG. 9; and

FIG. 11 is a schematic diagram of an apparatus according to the invention.

### DETAILED DESCRIPTION

The disclosure relates to a computer-implemented method of processing source data to create output data. Particularly, the disclosure relates to a computer-implemented method for processing image data as source data, for example, picture data in a video data.

Applications of such a technique comprise smoothing, noise reduction, edge detection, and scaling. In particular, the disclosure relates to and uses separable filters. The disclosure is implementable in hardware or software.

The teaching of the following patent disclosures is incorporated into this specification by reference: WO2020/188273 A, WO2019/111010 A and PCT/GB2022/052406.

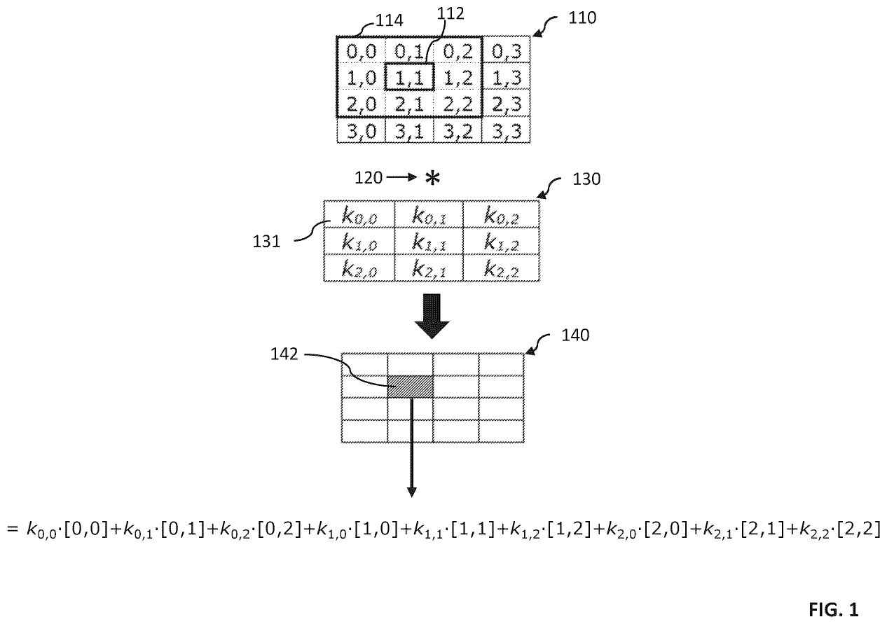

FIG. 1 shows an example of an input data, kernel and output data and provides useful context for understanding the invention.

Source data 110 in this example comprises 4×4 data points, with each data point being referenced by its location within the source data using indices i, j as is commonly used, where i represents the row and j represents the column in the source data 110. Source data 110 can be referred to as matrix I_{i,j}. As an example, source data point I_{0,0} is located at the top left corner of the illustration of the source data 110.

Source data 110 is usefully convolved using a 2D convolution with kernel 130 (see convolution operator 120 in FIG. 1) for several reasons, for example to perform image processing operations, such as to preform edge detection, blurring and sharpening. The 2D convolution may also be used with a downsampling or upsampling operation.

Kernel 130 in this example is a 3×3 2D matrix which comprises 9 filter coefficients k, with each filter coefficient, k, being referenced by its location in the kernel 130 also using indices i, j as is commonly used. Kernel 130 can be referred to as matrix K_{i,j}. As an example, kernel coefficient 131 at K_{0,0} (=k_{0,0}) shown in FIG. 1 is located at the top left corner of the kernel 130.

Output data 140 in this example comprises 4×4 data points and matches the size of source data 120. Each data point is the output data 140 is referenced by its location within the output data 140 using indices x, y as is commonly used, where x represents the row and y represents the column in the output data 140. Output data 140 can be referred to as matrix O_{x,y}. As an example, output data point O_{1,1} is located one row down, and one column across in the illustration of the output data 140, and in this example is referred to as output target data point 142 for the purposes of the below explanation.

2D convolution is performed on the source data 110 as would be known to persons skilled in the art, using kernel 130, to produce the output data 140.

The mathematical formulation of 2D convolution is given by, for a kernel K of size m×n, source or input data I and output data O, as follows:

$${O}_{x , y} = {\sum }_{i = 0}^{m - 1} {\sum }_{j = 0}^{n - 1} {K}_{i , j} \cdot {I}_{( i - ⌊ \frac{m}{2} ⌋ + x ) , ( j - ⌊ \frac{n}{2} ⌋ + y )}$$

As the skilled reader will anticipate, each output data point Oxy is a weighted sum of the source target data point 112 together with neighbouring data points 114 as defined by kernel 130. In other examples, the neighbouring data points may not be strictly neighbouring to the target data point 112 but may be associated with the target data point in some other way.

In the illustration of FIG. 1 source target data point 112 (=I_{1,1}) yields the following corresponding output target data point 142 (=O_{1,1}) as a result of the 2D convolution:

$$= {k}_{0 , 0} \cdot [ 0 , 0 ] + {k}_{0 , 1} \cdot [ 0 , 1 ] + {k}_{0 , 2} \cdot [ 0 , 2 ] + {k}_{1 , 0} \cdot [ 1 , 0 ] + {k}_{1 , 1} \cdot [ 1 , 1 ] + {k}_{1 , 2} \cdot [ 1 , 2 ] + {k}_{2 , 0} \cdot [ 2 , 0 ] + {k}_{2 , 1} \cdot [ 2 , 1 ] + {k}_{2 , 2} \cdot [ 2 , 2 ]$$

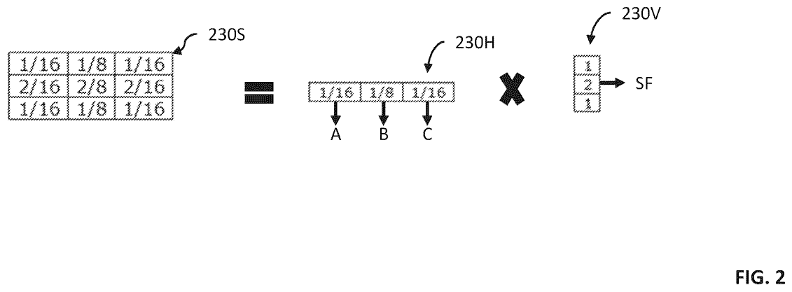

FIG. 2 shows an example 3×3 separable kernel 230S and provides useful context for understanding the invention. As is known in the art, separable convolution may be performed where the kernel is separable. An m×n kernel is said to be separable if there exists a pair of vectors with dimensions m×1 and 1×n such that the product of the vectors is equal to original kernel matrix.

Rather than convolving an image with an m×n kernel such as kernel 230S, one can first apply an m×1 kernel followed by an 1×n kernel. It is important to note that the convolutions in the expressions refer to the whole source data or image, not just one data point or pixel—the entire source data or image is convolved with one vector, after which the resulting intermediate data is convolved with the other vector. This means that two distinct passes are performed, rather than one.

From an algorithm analysis standpoint, the cost of performing the convolution is reduced from O(m*n) to O(m+n) per output data point, assuming the cost of performing a convolution pass is relatively cheap.

Referring back to FIG. 2, separable kernel 230S is shown as having a first horizontal kernel or vector 230H with dimensions 3×1, and a second vertical kernel or vector 230V with dimensions 1×3. The kernels are referred to as lower dimension kernels. As can be seen in FIG. 2, the kernel coefficients of the first horizontal vector 230H are labelled as coefficients A, B, C for ease of reference in the following description. Also, a scaling factor SF is derived from the second vertical vector 230V. The skilled person would understand that this arrangement may be reversed, with the scaling factor being derivable from the first horizontal vector 230H and the coefficients from the second vertical vector 230V.

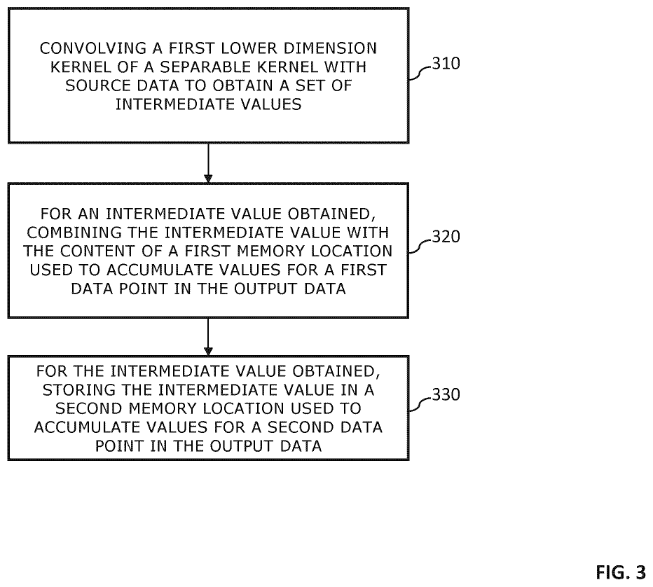

FIG. 3 is a flowchart explaining a first aspect of the invention. The flowchart outlines the following computer-implemented method of processing source data to create output data. The general method follows the above-mentioned separable convolution process to obtain the intermediate data using a first pass of the first horizontal vector. However, and importantly, the second pass is not performed in the same way. Instead, at least some of the intermediate data is used twice during each pass as each relevant intermediate data point is generated. Firstly, each generated intermediate data value is used to calculate or obtain a final value for an output data point in the output data that requires the same to be fully processed in accordance with the separable filter 230S, and secondly, the intermediate data is stored, at least once, to accumulate a value for another output data point. This concept is illustrated in more detail in the following description and allows for a reduction in memory and computations resources, allowing for the handling of particularly large input data, such as image data as part of a video signal at, for example, a relatively high resolution and frame rate. The invention is particularly, but not exclusively, suitable for processing real-time video data.

The method of FIG. 3 is as follows.

At step 310, the method comprises convolving a first lower dimension kernel, such as first horizontal vector 230H of a separable kernel, such as separable kernel 230S, with source data, such as source data 110, to obtain a set of intermediate values.

At step 320, the method comprises, for an intermediate value obtained for a target data point in the source data, combining the intermediate value with the content of a first memory location storing accumulated intermediate values for a first data point in the output data. This step is to create a final value for the first data point in the output data, wherein the final value corresponds to a value that the separable kernel would produce if the corresponding source data point were processed by the separable kernel.

At step 330, the method comprises, for the intermediate value obtained, storing the intermediate value in a second memory location related to a second data point of the output data, wherein the second data point requires the intermediate value so as to be processed according to the separable kernel.

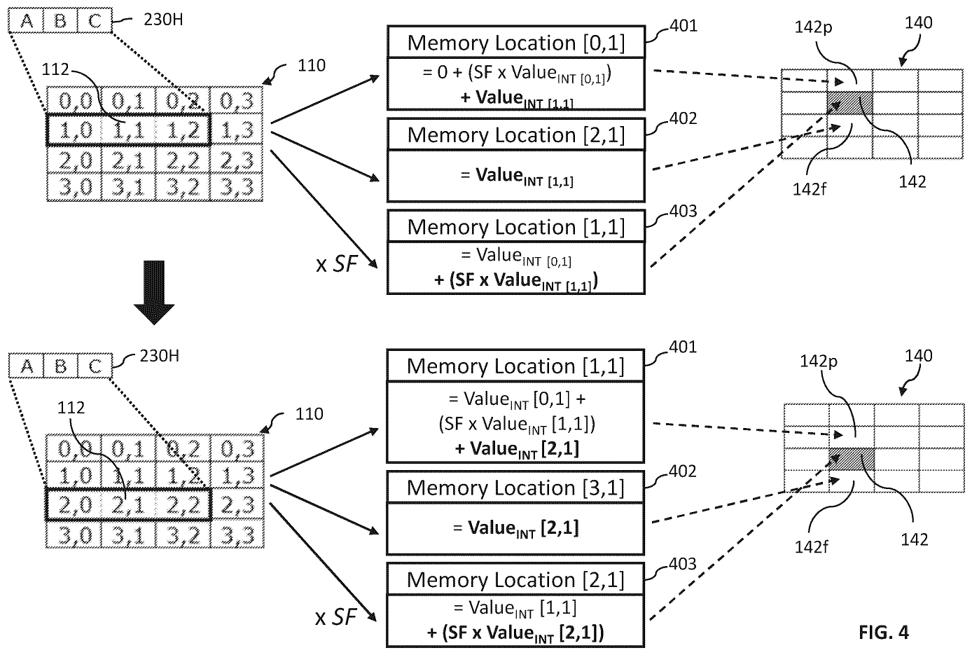

FIG. 4 is a block diagram showing in more detail how the generalised method described above would work in an exemplary embodiment of the invention. Two snapshots of the process are shown, with the first snapshot focusing on source target data point [1,1], and the second snapshot focusing on source target data point [2,1]. The general reference numeral 112 indicates the source target data point for each snapshot. In the example of FIG. 4, it is assumed that the output data is stored in a memory (not shown) which is accessible to a CPU performing this method in such a way so as not to introduce latency when processing the data, such as when processing images or frames in video data. Each data point in the output data 140 is stored primarily in the memory.

For this example to ease explanation, out of bounds data points, or pixels, are ignored.

The illustrated convolution step is captured in the first snapshot after processing source target data point [1,1] in accordance with the disclosed technique. In this first snapshot of the convolution process, the first horizontal vector or kernel 230H has been applied to source target data point [1,1] to obtain a corresponding intermediate value (Value_{INT [1,1]}). In other words, to obtain Value_{INT [1,1]} a summation of the following multiplications is made: coefficient A is multiplied with the source data value at I_{1,0}; coefficient B is multiplied with the value at I_{1,1}; coefficient C is multiplied with the value at I_{1,2}. As would be known to a skilled reader, this approach is repeated along the whole row i=1 of source data 110 for each target data point 112 in turn as j increases.

The intermediate value obtained Value_{INT [1,1]} is combined with the content of a first memory location [0,1] (reference numeral 401) which already stores an accumulated value for a first data point 142p in the output data, which was allocated “previously” as will become apparent from reading on. The first data point 142p is located at coordinates [0,1] in the output data. The first snapshot shows how a final value for the first data point 142p is created according to the process through the combination. In the specific example of FIG. 4, the first memory location stores the final value, however the final value can be stored elsewhere as desired. According to this process, the final value corresponds to a value that the separable kernel 230S would have produced if the corresponding source data point [1,1] were processed by the separable kernel 230S.

The intermediate value Value_{INT [1,1]} is also stored in a second memory location [2,1] (reference numeral 402) for future use when obtaining a final value for a second data point 142f located at point [2,1] in the output data 140.

As will be seen, the above two operations are shared with a later example embodiment in which downsampling is performed alongside the kernel convolution process.

However, in this example embodiment of FIG. 4, no downsampling is performed. The intermediate value Value_{INT [1,1]} is also accumulated with the contents of a third memory location [1,1] (reference numeral 403) for future use when obtaining a final value for a third data point 142 in the output data 140 at point [1,1]. The third data point 142 in the output data 140 corresponds to source target data point 112. However, prior to the accumulation, the scaling factor SF derived from the second lower dimension kernel 230V (from FIG. 2) is applied so that the final value will reflect what would have been obtained using traditional 2D convolution or equivalent separable convolution. Third memory location [1,1] at this first snapshot of the process had a value of Value_{INT [0,1]} which would have been obtained when first horizontal kernel 230H was applied to source data point [0,1] and the above method was followed (in that iteration, third memory location [1,1] would have been equivalent to the second memory location [2,1] in this iteration).

First memory location [0,1] is shown to have a value of 0 accumulated therein. This represents the fact that no row-wise convolution with first horizontal kernel 230H would have been conducted on any out of bounds pixels and represents the result that would have been obtained with a traditional 2D convolution of source data point [0,1] using separable filter 230S where out of bounds data points or pixels are treated as having zero value.

First memory location [0,1] is also shown to have a value of SF×Value_{INT [0,1]} accumulated therein which would have been obtained when first horizontal kernel 230H was applied to source data point [0,1].

FIG. 4 also shows a second snapshot showing the convolution process when horizontal kernel reaches row i=2 and the target data point becomes source data point [2,1]. Value_{INT [2,1]} is calculated as described above for Value_{INT [1,1]}, mutatis mutandis.

The first memory location 401 for this iteration of the convolution process “inherits” the value of, or more accurately is, the third memory location [1,1] of the previous row's process, and has added thereto the intermediate value Value_{INT [2,1]} for the source target pixel [2,1]. The accumulated value of memory location [1,1]=Value_{INT [0,1]}+(SF×Value_{INT [1,1]})+Value_{INT [2,1]}.

The second memory location 402 for this iteration of the process is a new or so far unused memory location [3,1] which is allocated for “future” data point 142f in the output data 140. This data point is called a “future” data point in the sense that it is only now becoming relevant as the convolution process proceeds. The intermediate value Value_{INT [2,1]} is stored therein.

The third memory location 403 for this iteration of the process “inherits” the value of, or more accurately is, the second memory location [2,1] of the previous row's process, and has added thereto the intermediate value Value_{INT [2,1]} for the source target pixel [2,1] scaled by the scaling factor SF. The accumulated value of memory location [2,1]=Value_{INT [1,1]}+(SF×Value_{INT [2,1]}).

Whilst the above discussion contemplates a row-wise implementation of the first horizontal kernel 230H, it would be possible to implement a column-wise variation using the second vertical kernel 230V as required, deriving a suitable scaling factor from the corresponding first horizontal kernel 230H. Indeed, if needed, a scaling factor could be applied to all intermediate values prior to storage in memory locations. However, it is advantageous in some circumstances to create a single scaling factor to reduce computational resources and memory read/writes in the process.

It may be advantageous to derive the first lower dimension kernel and a second lower dimension kernel from the separable kernel in such a way so that the second lower dimension kernel has a single non-unitary coefficient and deriving a scaling factor from the single non-unitary coefficient. The scaling factor may be one of the following: 2, 4, or 8.

While this method is generally applicable to any source data, a useful implementation is with digital image data, and with frames of video data.

The separable kernel in the illustrated example of FIG. 4 is a 3×3 Gaussian kernel. However, other suitable kernels may be used.

In some instances, it may be required to use a buffer memory space within a memory hardware that is more easily accessible to a CPU or equivalent processor running the method. The buffer memory space may be expensive in terms of financial cost, and so may be a scarce resource. In that case, an arrangement may be made in which the first memory location and the second memory location are the same memory location within a buffer to reuse memory space in the buffer.

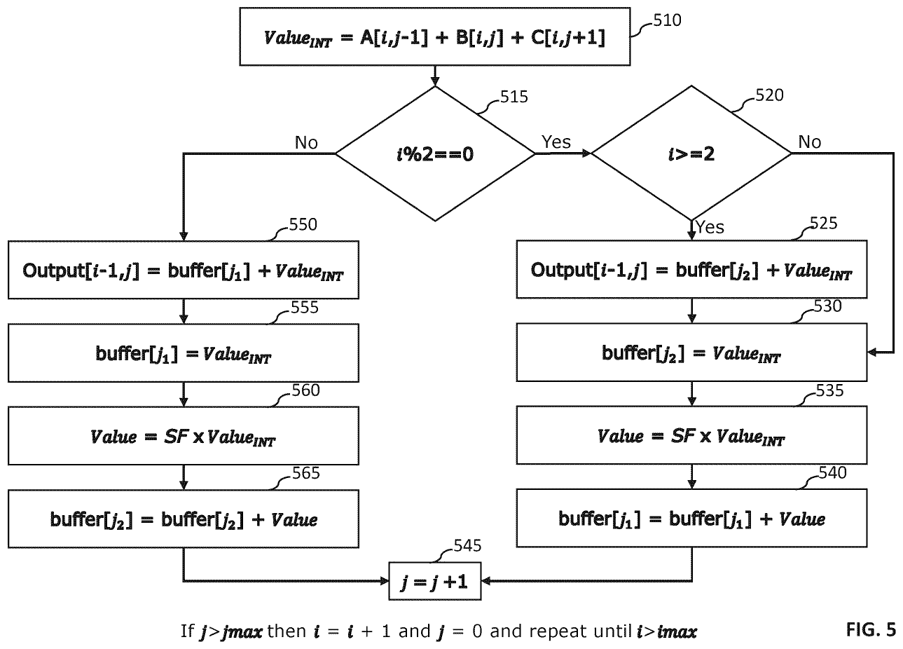

FIG. 5 is a flowchart showing a buffer embodiment which is able to reuse memory space while accumulating intermediate and scaled intermediate values in order to obtain final values in the output data.

The process of FIG. 5 has the following steps:

Step 510: an intermediate value Value_{INT} is determined for a target data point or pixel 112 in the source data 110 as described above. The target pixel 112 is at coordinates i, j in the source data 110.

Step 515: a determination is made to determine whether the row of the target pixel 112 is an even or an odd row of the input data 110. If even, the process moves to step 520. If odd, the process moves to step 550.

Step 520: a determination is made to determine whether the row of the target pixel 112 is the top row, i.e. i=0. If the row is the not the top row, the process moves to step 525. If the row is the top row, then the process moves to step 530.

Step 525: as the row is not the top row, there will be pre-stored accumulated values in a buffer location [j2] which is equivalent to the first memory location described above. The process adds the intermediate value to the contents of the buffer location [j2] and outputs the same to a separate memory location corresponding to a previous data point in the output data, e.g. 142p. The separate memory location may be on a DRAM which is slower to access than the buffer memory.

Step 530: buffer location [j2] takes on the value of the intermediate value and is equivalent to the second memory location described above.

Step 535: the intermediate value is scaled by the scaling factor SF. This scaled value is typically, but not necessarily, stored in a same memory location or register as used to hold the intermediate value.

Step 540: another buffer location [j1] is arranged to accumulate any previous value stored therein with the now scaled intermediate value and is equivalent to the third memory location described above.

Step 545: the target pixel is moved along the row by one data point or pixel and the process repeats. At this point, if there are no more pixels in the row, then the process moves down a row and repeats for the next row, until no more rows remain to be processed.

Step 550: following determination step 515, and as the row is odd, e.g. i=1, 3, 5, etc, there will be pre-stored accumulated values in a buffer location [j1] which is equivalent to the first memory location disclosed above. The process adds the intermediate value to the contents of the buffer location [j1] and outputs the same to a separate memory location corresponding to a previous data point in the output data, e.g. 142p. The separate memory location may be on a DRAM which is slower to access than the buffer memory.

Step 555: buffer location [j1] takes on the value of the intermediate value and is equivalent to the second memory location described above.

Step 535: the intermediate value is scaled by the scaling factor SF. This scaled value is typically, but not necessarily, stored in a same memory location or register as used to hold the intermediate value.

Step 540: another buffer location [j2] is arranged to accumulate any previous value stored therein with the now scaled intermediate value and is equivalent to the third memory location described above.

The process moves to step 545 as described above.

As will be realised, the buffer is equivalent to two rows of source data 110, and is used to accumulate two intermediate values (one of which is scaled by the scaling factor SF) before being used to create a final output value for a data point or pixel in the output data 140. In this way efficient memory usage is achieved with reduced latency because the buffer memory is quicker to access than other memory such as DRAM.

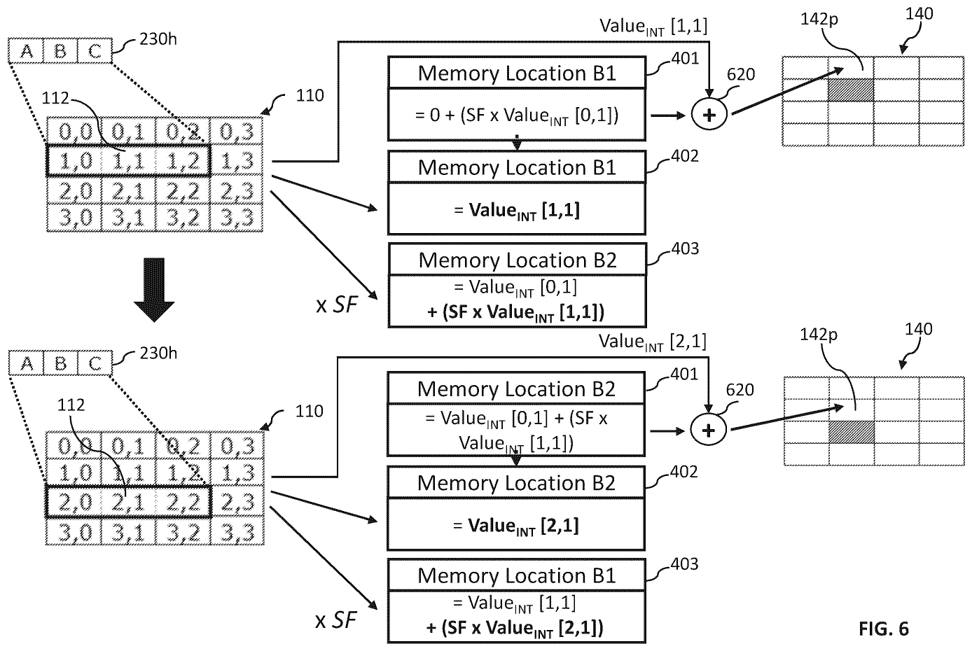

FIG. 6 is a block diagram showing in more detail how the generalised method described in FIG. 5 would work in another exemplary embodiment of the invention. FIG. 6 has many similarities to FIG. 4 and only the differences are described, with like reference signs denoting like features.

First and second snapshots of the process are shown in FIG. 6. Instead of first memory location 401 being a stand-alone memory location configured to store all data points of the output data 140, first memory location 401 is buffer B1. Buffer B1 is reused as described above and that teaching is not repeated.

In the first snapshot, once the intermediate value is obtained from source target pixel 112 and the accumulated content of buffer B1 (first memory location 401) is read and combined with the intermediate value, the buffer B1 is reused (second memory location 402) to store the intermediate value. The combination of the value of buffer B1 with the intermediate value is shown by accumulation unit 620, the output of which is sent to a separate memory location corresponding to a previous data point in the output data, e.g. 142p. The separate memory location may be on a DRAM which is slower to access than the buffer memory. Additionally, a second buffer location B2 (third memory location 403) is used to accumulate its contents with the scaled intermediate value for later use.

In the second snapshot representing source target pixel [2,1] in the row below prior source target pixel [1,1], the same process is repeated, but the first memory location 401 and the second memory location 402 are each buffer B2, and the third memory location 403 is buffer B1.

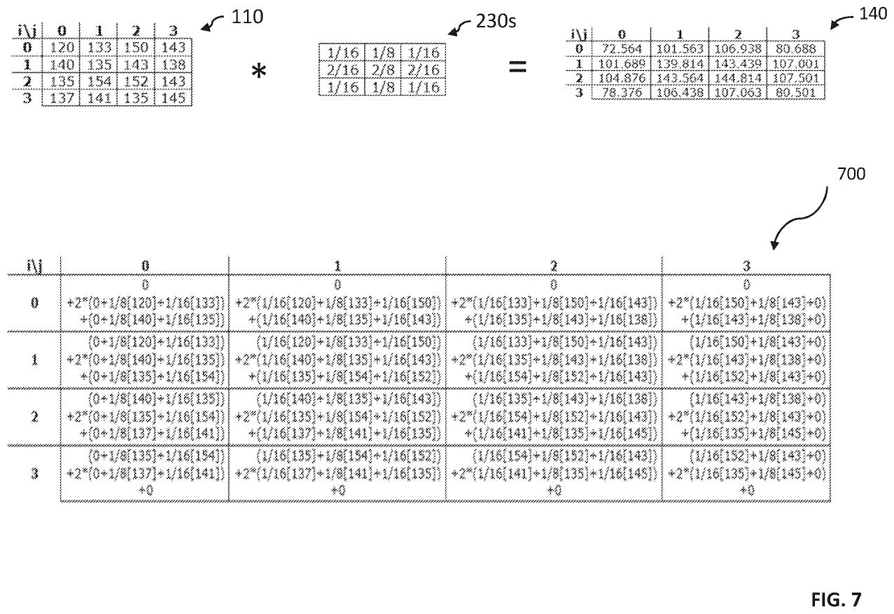

FIG. 7 is a generalised schematic showing example data values or pixel values for an example 4×4 source data 110. In this example, a 3×3 Gaussian kernel (separable) is used, and coefficients A= 1/16; B=⅛; and C= 1/16 with scaling factor SF=2 can be derived therefrom. Output data 140 is shown with worked out final data point values. Additionally, a representation 700 of the accumulation of the intermediate values for each output data point, scaled appropriate, is shown to aid understanding. Typically, three accumulations are made for each data point, with each being represented by its own row within the representation 700. Out of bounds data points or pixels are treated as zero, or alternatively padding is used as is known in the art. Padding is where out of bounds data points or pixels are given a non-zero value. For example an out of bounds data point or pixel is given the value of the nearest pixel value in the input data. When out of bounds pixels are treated as zero, no calculations are performed for the top and bottom rows of the input data 110, saving on computational resource.

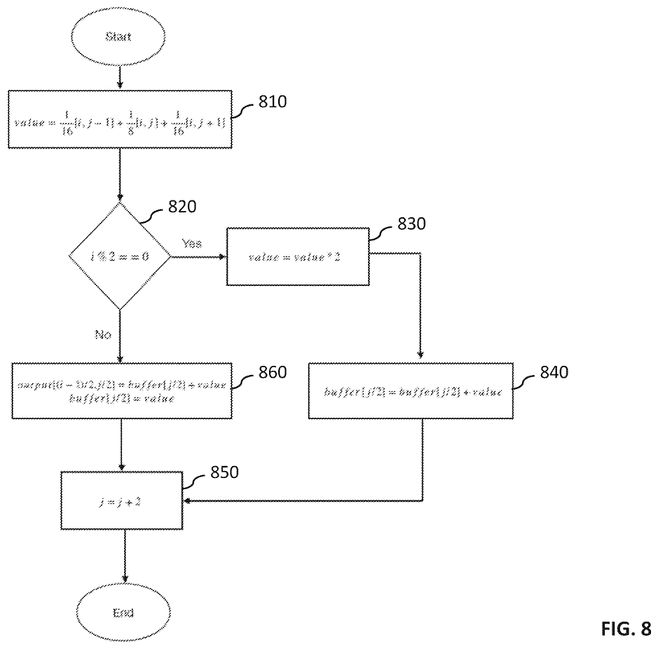

FIG. 8 is a flow diagram of a method of processing a data signal according to another aspect of the invention. The flow diagram shows the method of processing a data signal where the data signal is downscaled and processed using the separable kernel 230S.

The process of FIG. 8 has the following steps:
Step 810: an intermediate value for a source target data point [i,j] is computed using the first lower dimension, or horizontal, kernel 230H as already described above. In this example, the intermediate value computed is stored as parameter “value”.
Step 820: the method checks if the value of i of the data point is divisible by 2 without a remainder. If the value of i is divisible by 2 without a remainder, then the method progresses to step 830, otherwise the method progresses to step 860.
Step 830: the value calculated at step 810 is multiplied by 2 (which is derived from the vertical kernel 230V of FIG. 2), and the resulting value then overwrites the value that is stored in the parameter “value”.
Step 840: the parameter “value” is added to whatever is stored in a buffer [j/2] to result in an updated buffer [j/2].
Step 850: the method updates the value of j by adding 2 to it because this method is for downscaling by a factor of 2. The method goes back to the start.

If at step 820 the value of i is not divisible by 2 without a remainder (i.e. the row being processed is odd), then the method progresses to step 860.

Step 860: the method outputs a value output [(i−1)/2,j/2] using whatever is stored in the buffer [j/2] (the first memory location) added to the value stored in the parameter “value”. Buffer [j/2] is then updated to be the value in the parameter “value”. The method then proceeds to step 850 described above. In this way, resources when computing a processed value for a subsequent data point are saved as the value stored in buffer [j/2] can be reused instead of calculating a new value for its corresponding data point. Additionally, fewer memory resources are needed, especially in fast-access memory close to a CPU or GPU.

This process repeats for each source target data point [i,j], but as explained already, missing every other data point both row-wise and column-wise. In other words, once the end of the row is reached in the source data 110, the process moves as follows i=i+2.

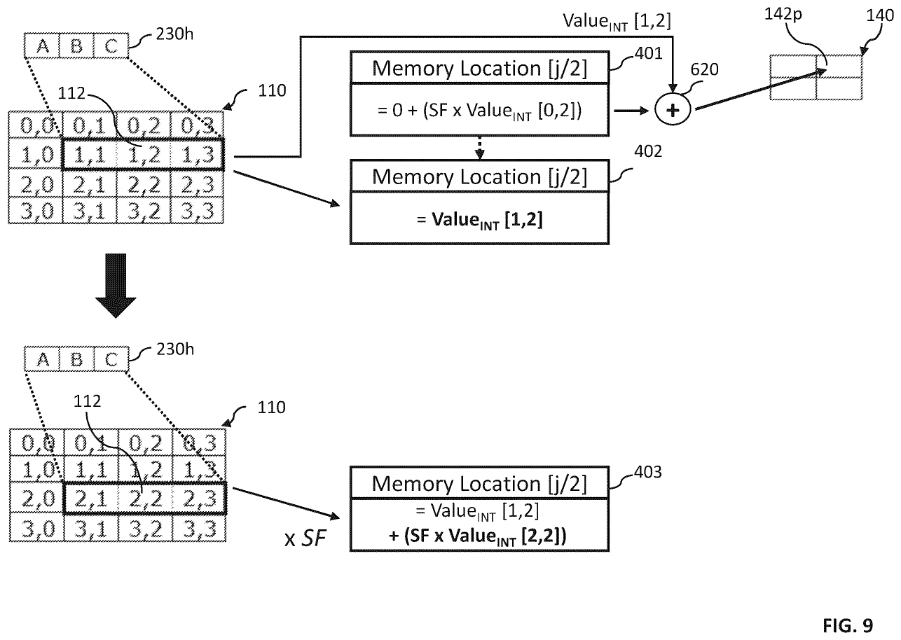

FIG. 9 is a block diagram showing in more detail how the generalised method described in FIG. 8 would work in another exemplary embodiment of the invention. FIG. 9 has similarities to FIG. 6 and only the differences are described in relation to the downscaling or downsampling aspect, with like reference signs denoting like features.

First and second snapshots of the process are shown in FIG. 9. Instead of first memory location 401 being a stand-alone memory location configured to store all data points of the output data 140, first memory location 401 is a buffer [j/2]. Buffer [j/2] is reused as each row is processed as described above and that teaching is not repeated.

In the first snapshot, the target data point 112 is different to that shown in FIG. 6, with the target data point being at location [1,2] in FIG. 9. As will be appreciated from FIG. 8, only every other data point on each row becomes a target data point from which an intermediate is derived, and not every data point on each row as taught in the FIG. 6 embodiment. This is because of the concurrent downsampling operation of FIG. 8. Once the intermediate value is obtained from source target pixel 112 and the accumulated content of buffer [j/2] (first memory location 401) is read and combined with the intermediate value, the buffer [j/2] is reused (second memory location 402) to store the intermediate value. The combination of the value of buffer [j/2] with the intermediate value is shown by accumulation unit 620, the output of which is sent to a separate memory location corresponding to a previous data point in the output data, e.g. 142p. In this case, the processing of input data value [1,2] completes the accumulation of values for processing input data value [0,2] according to the kernel 230S, and so a final value is determined for output data point [0,1]. Note that output data point [0,1] corresponds, via the downsampling, to input data point [0,2]. Of course, other downsampling and upsampling variations are contemplated. The separate memory location may be on a DRAM which is slower to access than the buffer memory. Notice that in this example, a second buffer location B2 is not needed and is not used.

In the second snapshot representing source target pixel [2,1] in the row below prior source target pixel [1,1], the same process is repeated, but the third memory location 403 is also buffer B1. The intermediate value for source target pixel [2,1] is added to the value stored in buffer B1 and the combined total is also stored in buffer B1.

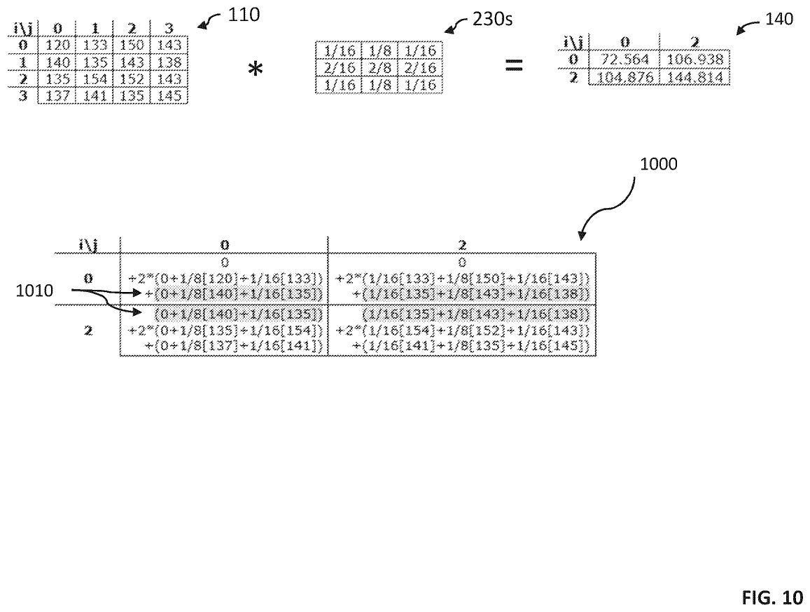

FIG. 10 is a generalised schematic showing example data values or pixel values for an example 4×4 source data 110 according to the process described in relation to FIG. 8 and FIG. 9. In this example, a 3×3 Gaussian kernel (separable) is used, and coefficients A= 1/16; B=⅛; and C= 1/16 with scaling factor SF=2 can be derived therefrom. Output data 140 is shown with worked out final data point values. The coordinates of the output data are given in terms of the input data 110 so that an easy relationship can be made between the output data points and the input data points which have been processed by the kernel 230S or equivalent thereto to arrive at the output data points. As can be seen, in this downsampling embodiment, the output data 140 is half the size of the input data 110, in other words can be expressed as 2×2 output data 140. Additionally, a representation 1000 of the accumulation of the intermediate values for each output data point, scaled appropriately, is shown to aid understanding. Typically, three accumulations are made for each data point, with each being represented by its own row within the representation 1000. Again, representation 1000 uses coordinates from the input data 110 to make a comparison more straightforward. As can be seen, intermediate values shown as 1010 corresponding to row 1 of the source data 110 is used in the determination of both output data rows. This principle would carry on throughout the output data if larger source data were used. Out of bounds data points or pixels are treated as zero. No calculations are performed for the top and bottom rows of the input data 110, saving on computational resource.

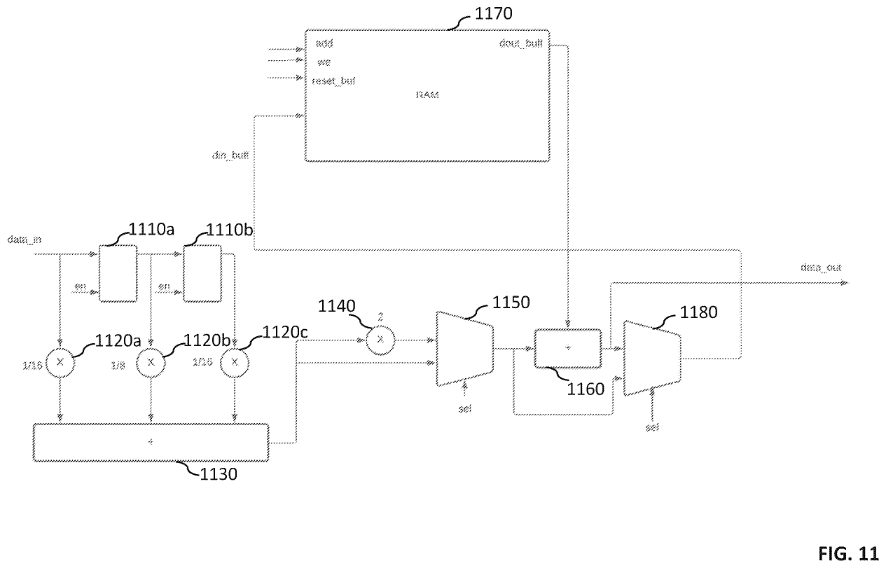

FIG. 11 is a schematic diagram of an apparatus according to the invention. The apparatus is configured to perform the method of FIGS. 8-10 and is straightforwardly modifiable to perform the method of FIGS. 3-7. An input signal data_in is processed through blocks 1110a and 1110b to prepare the input data signal for multiplication with the first lower dimension kernel 230H. The selected part of the input signal is then processed through multipliers 1120a, 1120b and 1120c which have multiplication values derived from the first lower dimension kernel 230H, those being 1/16, ⅛ and 1/16 respectively. The result of multipliers 1120a, 1120b and 1120c is then summed at summation module 1030 to create the intermediate value. The output of summation module 1130 is then input to selector 1150 and is also multiplied by the scaling factor SF at module 1140 (in this example SF=2) and input to selector 1150. Selector 1150 chooses to select either the unscaled or scaled intermediate value according to the method outlined above. The result of the selection at selector 1150 is then inputted to summing module 1160 to be summed with the data out buffer signal (dout_buff) which is the output of the buffer 1170 as required by the method described above and the result of the summation is then inputted to the second selector 1180 and also output as data_out. The output of the summing module 1160 is also input directly into the second selector module 1180. Depending on the method described above, the second selector 1180 selects one of the two inputs to be sent for storage in the buffer 1170 as data in buffer signal (din_buff).

The method may be implemented in one of the following: a dedicated hardware such as an Application Specific Integrated Circuit, ASIC, or Field Programmable Gate Arrays, FPGA; software running on a Central Processing Unit, CPU; software running on a Graphical Processing Unit, GPU.

The skilled person would understand from this disclosure how to design and build an apparatus for processing source data in accordance with the above embodiments.

The method may be captured on a computer-readable medium comprising instructions which when executed cause a processor to perform the method of any of the above embodiments. The method may be encapsulated by a computer program, which may be transmitted as a signal.

The above embodiments are to be understood as illustrative examples. Further embodiments are envisaged. It is to be understood that any feature described in relation to any one embodiment may be used alone or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A computer-implemented method of processing source data to create output data, the method comprising:
convolving a first lower dimension kernel of a separable kernel with the source data to obtain a set of intermediate values;
for an intermediate value obtained for a target data point in the source data:
combining the intermediate value with the content of a first memory location storing accumulated intermediate values for a first data point in the output data to create a final value for the first data point in the output data, wherein the final value corresponds to a value that the separable kernel would produce if the corresponding source data point were processed by the separable kernel; and
storing the intermediate value in a second memory location related to a second data point of the output data, wherein the second data point requires the intermediate value so as to be processed according to the separable kernel.

2. The computer-implemented method of claim 1, wherein the source data is digital image data.

3. The computer-implemented method of claim 1, wherein the separable kernel is one of: a 2D separable kernel; a 3×3 separable kernel; a 3×3 Gaussian kernel.

4. The computer-implemented method of claim 1, wherein the first lower dimension kernel is one of: a 1D kernel; a 1D horizontal filter; a 3×1 kernel; a 1D vertical filter; a 1×3 kernel; and a symmetrical kernel of any of the aforementioned kernel types.

5. The computer-implemented method of claim 1, wherein the first lower dimension kernel is a 1D horizontal kernel and the step of convolving a first lower dimension kernel of the separable kernel with the source data to obtain a set of intermediate values comprises applying the first lower dimension kernel to each data point of the source data in a row-wise manner, and the first data point and the second data point in the output data are arranged in the same column.

6. The computer-implemented method of claim 1, wherein the first lower dimension kernel is a 1D vertical kernel and the step of convolving a first lower dimension kernel of the separable kernel with the source data to obtain a set of intermediate values comprises applying the first lower dimension kernel to each data point of the source data in a column-wise manner, and the first data point and the second data point in the output data are arranged in the same row.

7. The computer-implemented method of claim 1, wherein the first data point and the second data point are separated by a data point in the output data corresponding to the target data point of the source signal.

8. The computer-implemented method of claim 1, wherein the method further comprises:
deriving the first lower dimension kernel and a second lower dimension kernel from the separable kernel in such a way so that the second lower dimension kernel has a single non-unitary coefficient, and deriving a scaling factor from the single non-unitary coefficient.

9. The computer-implemented method of claim 1, wherein the scaling factor is one of the following: 2, 4, or 8.

10. The computer-implemented method of claim 8, wherein the method comprises applying the scaling factor to the intermediate value and adding the intermediate value to the content of a third memory location used to accumulate values for a target data point in the output data corresponding to the target data point in the input data.

11. The computer-implemented method of claim 1, wherein the first memory location and the second memory location are the same memory location within a buffer so as to reuse memory space in the buffer.

12. The computer-implemented method of claim 10, wherein the third memory location is in the buffer and is a separate memory location to the first and second memory locations.

13. The computer-implemented method of claim 10, wherein each of the first memory location, the second memory location and the third memory location are separate locations corresponding to data points in the output data.

14. The computer-implemented method of claim 1, wherein the method comprises moving to a second target data point in the input data, obtaining a resulting second intermediate value, applying the scaling factor to the resulting second intermediate value and combining the scaled subsequent intermediate value with the intermediate value stored in the second memory location.

15. The computer-implemented method of claim 14, wherein the second target data point is in the row immediately below the target data point.

16. The computer-implemented method of claim 14, wherein the method comprises moving to a third target data point in the input data, and repeating the method.

17. The computer-implemented method of claim 16, wherein the third target data point is in the row immediately below the second data point.

18. The computer-implemented method of claim 1, wherein the method comprises outputting the final value.

19. The computer-implemented method of claim 18, wherein the outputting the final value comprises:
outputting the final value to a memory location storing the output data; or
output for streaming.

20. The computer-implemented method of claim 1, wherein the method is implemented in one of the following: a dedicated hardware such as an Application Specific Integrated Circuit, ASIC, or Field Programmable Gate Arrays, FPGA; software running on a Central Processing Unit, CPU; software running on a Graphical Processing Unit, GPU.

21. An apparatus for processing a source data, the apparatus is arranged to perform the computer-implemented method of claim 1.

22. A non-transitory computer-readable medium comprising instructions which when executed cause a processor to perform the method of claim 1.
